(19) United States
(12) Patent Application Publication
(10) Pub. No.: US 2003/0202927 A1
(43) Pub. Date: Oct. 30, 2003

(54) Reduction of ammonia in flue gas and fly ash

(76) Inventors: Rafic Y. Minkara, Kennesaw, GA (US); William A. Farone, Irvine, CA (US)

Correspondence Address: Cynthia H. O'Donohue, Applied Power Concepts, Inc., 411 East Julianna Street, Anaheim, CA, 92801, US

(21) Appl. No.: 10/421,191

(22) Filed: Apr. 23, 2003

Related U.S. Application Data
(60) Provisional application No. 60/375,550, filed on Apr. 24, 2002.

(51) Int. Cl. B01D 53/58

(52) U.S. Cl. 423/237; 423/239.1; 502/324

(57) ABSTRACT

A process is described that removes by oxidation the excess ammonia (NH₃) gas from flue gases that have been subjected to selective catalytic reduction (SCR) and selective non-catalytic reduction (SNCR) of oxides of nitrogen (NOx) by ammonia injection. Methods for the removal of residual ammonia from flue gases prior to deposition on fly ash are discussed.

### RELATED APPLICATIONS

This application under 35 U.S.C. §119(e) claims the benefit of U.S. Provisional Application No. 60/375,550, filed Apr. 24, 2002.

### FIELD OF INVENTION

The present invention is directed towards a process that removes by catalytic oxidation the excess ammonia (NH₃) gas from flue gases that have been subjected to selective catalytic reduction (SCR) and selective non-catalytic reduction (SNCR) of oxides of nitrogen (NOₓ) by ammonia injection. More specifically the invention relates to methods for the removal of residual ammonia from flue gases prior to deposition on fly ash.

### BACKGROUND OF THE INVENTION

The following description of the background of the invention is provided to aid in understanding the invention, but is not admitted to be, or to describe, prior art to the invention. All publications are incorporated by reference in their entirety.

To meet the reduced levels of NOₓ emissions from power stations, as required by environmental regulations, many fossil fuel-fired electric generating units are being equipped with either selective catalytic reduction (SCR) or selective non-catalytic reduction (SNCR) technologies. In SCR, the most common method used is to inject ammonia or urea based reagents in the presence of a vanadium oxide catalyst where the ammonia reacts to reduce the oxides of nitrogen. The SCR system operates at flue gas temperatures ranging between 350° C. and 450° C. In SNCR, the most common method used is to inject ammonia or urea based reagents into the upper furnace to reduce the oxides of nitrogen without the use of a catalyst. The SNCR system operates at flue gas temperatures ranging between 850° C. and 1150° C.

At coal-fired power plants, ammonia injection systems for SCR and SNCR systems are typically installed in the high-temperature and high-dust region of the flue gas stream which typically is prior to ash collection. One common problem with the SCR and SNCR technologies is that some residual ammonia, known as ammonia slip, negatively impacts downstream components and processes such as: air pre-heater fouling, fly ash contamination, and ammonia gas emission to the atmosphere. The ammonia slip problem is further exacerbated as the result of SCR catalyst surface deterioration as well as misdistribution in flue gas velocity, temperature, and concentrations of ammonia and NOₓ.

An additional problem with the current methods is that increased ammonia injection will more efficiently remove the oxides of nitrogen but then the excess ammonia will result in increased ammonia slip in the flue gas. In coal-fired power plants this excess ammonia can, in addition, contaminate the resulting coal based fly ash.

There have been other attempts to remove the ammonia that results from its use to reduce the NOₓ and other impurities from the flue gases. In U.S. Pat. No. 3,812,236 the effluent from an ammonia plant was treated with an oxidation catalyst containing manganese oxide at a temperature of 200° C. to 800° C. This effluent was primarily steam. Shiraishi et al in U.S. Pat. No. 4,003,978 suggested that manganese oxide showed high activity for the ammonia oxidation reaction at high temperatures but this patent also taught that there was a side reaction that produced harmful nitric oxides. Sin et al. in U.S. Pat. No. 4,419,274 also suggested the use of a single component catalyst; however, again nitric oxides were formed which are highly undesirable. Spokoyny in U.S. Pat. No. 6,264,905 proposed using an adsorbent for removing ammonia in both SCR and SNCR processes. This adsorbent has to be regenerated to maintain its functionality.

Even in power plants that are based on natural gas or oil, the environmental effects of the exhausted ammonia is undesirable. The EPA has enacted a variety of regulatory initiatives aimed at reducing NOₓ. It was determined that the combustion of fossil fuels is the major source of NOₓ emissions. These control regulations were established by the EPA under Title IV of the Clean Air Act Amendments of 1990 (CAAA90). In July 1997 the EPA proposed another change in the New Source Performance Standards and these revisions were based on the performance that can be achieved by SCR technology.

Fly ash produced at coal-fired power plants is commonly used in concrete applications as a pozzolanic admixture and for partial replacement for cement. Fly ash consists of alumino-silicate glass that reacts under the high alkaline condition of concrete and mortar to form additional cementitious compounds. Fly ash is an essential component in high performance concrete. Fly ash contributes many beneficial characteristics to concrete including increased density and long-term strength, decreased permeability and improved durability to chemical attack. Also, fly ash improves the workability of fresh concrete.

When ammonia contaminated fly ash is used in Portland cement based mortar and concrete applications, the ammonium salts dissolve in water to form NH₄⁺. Under the high pH (pH>12) condition created by cement alkali, ammonium cations (NH₄⁺) are converted to dissolved ammonia gas (NH₃). Ammonia gas evolves from the fresh mortar or concrete mix into the air exposing concrete workers. The rate of ammonia gas evolution depends on ammonia concentration, mixing intensive, exposed surface, and ambient temperature. While it is believed that the ammonia that evolves has no measurable effect on concrete quality (strength, permeability, etc.), the ammonia gas can range from mildly unpleasant to a potential health hazard. Ammonia odors are detected by the human nose at 5 to 10 ppm levels. The OSHA threshold and permissible limits are set at 25 and 35 ppm for TWA (8-hr) and STEL (15-min), respectively. Ammonia gas concentration between 150 and 200 ppm can create a general discomfort. At concentrations between 400 and 700 ppm ammonia gas can cause pronounced irritation. At 500 ppm ammonia gas is immediately dangerous to health. At 2,000 ppm, death can occur within minutes.

Other than OSHA exposure limits, there are no current regulatory, industry or ASTM standards or guidelines for acceptable levels of ammonia in fly ash. However, based on industry experience, fly ash with ammonia concentration at less than 100 mg/kg does not appear to produce a noticeable odor in Ready-Mix concrete. Depending on site and weather conditions, fly ash with ammonia concentration ranging between 100 and 200 mg/kg may result in unpleasant or unsafe concrete placement and finishing work environment. Fly ash with ammonia concentration exceeding 200 mg/kg would produce unacceptable odor when used in Ready-Mixed concrete applications.

In addition to the risk of human exposure to ammonia gas evolving from concrete produced using ammonia laden ash, the disposal of ammonia laden ash in landfills and ponds at coal burning power stations could also create potential risks to human and the environment. Ammonium salt compounds in fly ash are extremely soluble. Upon contact with water, the ammonium salts leach into the water and could be carried to ground water and nearby rivers and streams causing potential environmental damage such as ground water contamination, fish kill and eutrophication. Ammonia gas could also evolve upon wetting of alkaline fly ashes, such as those generated from the combustion of western sub-bituminous coal. Water conditioning and wet disposal of alkaline fly ashes would expose power plant workers to ammonia gas.

The process to be described herein uses a second catalytic system downstream from the primary selective catalytic reduction catalyst to remove the ammonia slip by reacting the ammonia with residual oxygen in the flue gas to form nitrogen gas and water vapor.

In discussing the process and catalysts some general concepts are useful. Generally, under a specific set of conditions of temperature, surface to volume ratio, and inlet and outlet concentrations, catalysts are considered in terms of a parameter known as space velocity. The space velocity is the volume of the gas that can be treated in a given period of time (at the temperature and at the desired inlet and outlet concentrations) divided by the volume of the catalyst. As an example, a catalyst that reduced ammonia from 100 ppm to 10 ppm at 250° C. could have a hypothetical space velocity of 100/min. Thus, if the flow rate to be treated was 10,000 ft³/min, then 100 ft³ of catalyst would be used. This volume can be reduced by changing the surface area of the catalyst since catalyzed gas phase reactions are based on the available surface area for the reaction. Space velocity has been used as a means of estimating the amount of catalyst needed once the general function and shape is known. For example, the 100 ft³ of a catalyst as described above could be 100 ft2 by 1 foot deep, 50 ft² by 2 ft deep or any other dimension that provided the needed active volume. The linear flow rate would be different for each configuration as the linear flow rate is based on the volumetric flow rate divided by the cross sectional area but the total time for the reaction would remain the same as long as the reactive volume is the same.

For selective catalytic reduction (SCR) of oxides of nitrogen with ammonia to work well and result in the lowest values of NOₓ, it is preferable to be able to use excess ammonia. However, when the quantity of ammonia used is high enough to effectively remove the NOₓ through SCR, some of the excess ammonia will go through the catalyst unchanged and exit as ammonia slip in the flue gases creating the problem of a toxic reactive gas in the exiting gases. Another major problem created by the excess ammonia exiting in the flue gases in particular from coal fired plants is that the ammonia contaminates the fly ash that is intended for use in mixtures with cement to make concrete.

### BRIEF DESCRIPTION OF THE DRAWINGS

FIG. 1 Illustrates diagrammatically the experimental apparatus used for testing the efficiency of the ammonia oxidation catalyst.

FIG. 2 Depicts typical ammonia calibrations at 930 cm⁻¹.

FIG. 3 Depicts typical ammonia calibrations at 966 cm⁻¹.

FIG. 4 Depicts thermodynamic predictions for ammonia oxidation.

FIG. 5 Depicts ammonia reduction at 12 L/minute measured at 966 cm⁻¹.

FIG. 6 Depicts ammonia reduction at 12 L/minute measured at 930 cm⁻¹.

FIG. 7 Depicts ammonia reduction at 2 L/minute measured at 966 cm⁻¹.

FIG. 8 Depicts ammonia reduction at 2 L/minute measured at 930 cm

### SUMMARY OF THE INVENTION

It is the objective of this invention to provide commercially viable process that reduces the ammonia concentration to levels that will not contaminate the fly ash from coal fired plants and will additionally reduce the present undesirable emissions levels of ammonia in both coal fired plants and other plants that use other hydrocarbon fuels. One aspect of this invention is the reduction of the excess ammonia that is present in the exiting flue gases when ammonia is used with SCR catalysts to remove NOx from the exhaust gases. In another aspect of this invention the residual ammonia that is deposited in the fly ash by the exiting flue gases is reduced by the described process.

Definitions

In accordance with the present invention and as used herein, the following terms are defined with the following meanings, unless explicitly stated otherwise.

The term “SCR” refers to selective catalytic reduction.

The term “SNCR” refers to selective non-catalytic reduction.

The term “AOC” refers to ammonia oxidation catalyst.

The term “space velocity” refers to the volume of the gas that can be treated in a given period of time (at the temperature and at the desired inlet and outlet concentrations) divided by the volume of the catalyst.

The term “removal of ammonia” as used herein refers to the reduction of the ammonia concentration in flue gases to below 2 ppm.

The term “FTIR” refers to Fourier transform infrared spectroscopy.

The term “enhancing” refers to increasing or improving a specific property.

The term “ammonia slip” refers to the amount of unused ammonia in processes where ammonia is provided to SNCR and/or SCR processes for reducing NOₓ pollution in flue gases.

The terms, “Ready-Mix” and “Ready-Mixed” refer to concrete premixed at concrete producing plants and delivered to sites in a slurry form.

The term “Portland cement” refers to the cement used in most Ready-Mix and precast concrete applications and has well established composition and performance specification (ASTM and CSA).

The term “CSA” refers to the Canadian Standards Association.

The term “ASTM” refers to American Society for Testing and Materials. The following well known chemicals are referred to in the specification and the claims. Abbreviations and common names are provided.

CO; carbon monoxide

NOₓ; oxides of nitrogen

NH₃; ammonia

SOₓ; oxides of sulfur

CO₂; carbon dioxide

O₂; oxygen

N₂; nitrogen gas

### DETAILED DESCRIPTION OF THE INVENTION

One of the specific objectives of this invention was to develop a process that would reduce the ammonia slip to lower levels (2 ppm or less) under flue gas conditions that had very low amounts of oxygen (about 2%) and that would operate in the presence of oxides of sulfur, carbon monoxide and water vapor.

The process disclosed herein added a highly efficient ammonia oxidation catalyst (AOC) downstream of the selective catalytic reduction or the selective non-catalytic reduction system to remove the undesirable ammonia slip by reacting it with the residual oxygen present in the flue gas. Surprisingly, it was found that certain ammonia oxidation catalysts can be used for this purpose even though there were only small amounts of residual oxygen in the flue gas. The flue gas also contains several potentially inhibitory chemicals. Unexpectedly, levels of ammonia of 25 ppm were reduced to levels of about 1 ppm without the production of additional oxides of nitrogen.

Ammonia and urea based reagents are used as an SCR and SNCR agent for the reduction of NOₓ. The criteria for an AOC for placement downstream from the SRC and SNCR were:

(a) material capable of oxidizing ammonia at flue gas temperatures, oxygen concentration, and flow rates;

(b) material capable of functioning in presence of oxides of sulfur and nitrogen;

(c) material that would not produce additional oxides of nitrogen by side reactions of the oxidation of ammonia; and

(d) material that would increase the reduction of NOₓ such that the exiting levels of ammonia would be 2 ppm or less.

The material that performed the above function was surprisingly found to be a manganese catalyst prepared by depositing a solution of manganese acetate on alumina. The alumina was calcined at approximately 850° C. for at least 30 minutes. The degradation products of the calcining step were basically carbon dioxide and water. This preparation is preferred over the use of salts such as nitrates that emit oxides of nitrogen in the catalyst preparation.

This catalyst has a brown to dark brown color consistent with the color and structure of manganese dioxide, MnO₂. To present no other oxides of manganese have this distinctive brown coloration.

The use of manganese dioxide on alumina reduced ammonia levels at high levels of ammonia. Ammonia was reduced from 400-500 ppm to below 10 ppm. The process of this instant invention as described reduced the ammonia levels that could be. as high as 80 ppm exiting the SCR catalyst to 2 ppm (v/v) or less. It was further found that when the amount of excess ammonia was present in concentrations of about 20 ppm, typical of a useful excess amount in an SCR catalyst, the ammonia could be reduced to below 2 ppm at 250° C. or higher.

### EXAMPLE 1

### Thermodynamics Calculations

Thermodynamics calculations were performed using equilibrium software. The purpose of these calculations was to determine whether the catalyst would function in the range of temperatures that could theoretically reduce the ammonia to the largest extent without increasing the NOₓ output. The input data were the initial components, gaseous ammonia and air, the concentrations of the components, ammonia and air, temperature and pressure. The output was a quantified equilibrium mixture of components in both gas and liquid phases which has the greatest thermodynamic stability at a given temperature and pressure. This was done at atmospheric pressure for temperatures ranging from 27° to 727° C. and for cases in which there was no air present and in which varied amounts of air were present in the system.

Initial thermodynamic calculations showed that oxidation of ammonia goes to completion at all temperatures between 27° C. (room temperature) and 727° C. when there was a stoichiometric amount of oxygen present in the system based on reaction (1).

4NH₃+3O₂→2N₂+6H₂O (1)

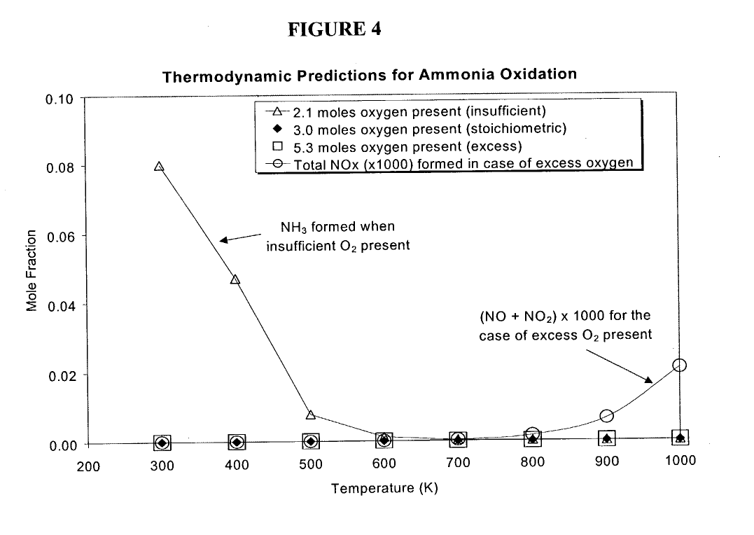

Slightly less amounts of air/oxygen resulted in incomplete oxidation of NH₃ at temperatures lower than 427° C., while temperatures higher than 527° C. showed complete degradation of the ammonia. The presence of excess air, however, allowed formation of more NOₓ (both NO and NO₂). FIG. 4 shows the predicted mole fraction of ammonia left versus the temperature at which the reaction was carried out. A mole fraction of 1.0×10⁻⁶ is equal to 1.0 ppm. Also shown is the total NOₓ formed in the case of excess air. The total NOₓ has been multiplied by a factor of 1000 to put it on scale, but that the total amount of NOₓ predicted to form was below 0.07 ppm at 327° C.

The thermodynamic calculations indicated the reaction should occur over a wide temperature range as long as it was not significantly above 350° C. at which point NOₓ could potentially form. Thus it was critical to the process to find a catalyst that would work below 350° C. Thermodynamics calculations could not predict the reaction rate which had to be determined experimentally. Experimental data was required to determine if the rate of the reaction was reasonable for the time that the gas was flowing through a catalyst bed.

The kinetics of the system were addressed using a first order rate equation (2):

$$\frac{- ⅆ [ {NH}_{3} ]}{ⅆ t} = k [ {NH}_{3} ] \qquad ( 2 )$$

Although the reactants to be considered were NH₃, O₂, and the catalyst, the latter two were in excess and therefore remained essentially at constant levels throughout the experiment. Equation (2) can be integrated to give equation (3):

$$ln ( \frac{{[ {NH}_{3} ]}_{o}}{[ {NH}_{3} ]} ) = k t \qquad ( 3 )$$

where [NH₃]ₒ was the initial NH₃ concentration, [NH₃] was its concentration at a later time, t, and k was the rate constant. The initial and final NH₃ concentrations were measured by FTIR.

The dependence of the rate constants on temperature was analyzed according to the Arrhenius expression, equation (4):

$$k = A {ⅇ}^{\frac{- {E}_{a}}{R T}} o r ln k = ln A - \frac{{E}_{a}}{R T} \qquad ( 4 )$$

In the above equations, k was the rate constant, A was the “pre-exponential factor”, Ea was the activation energy, R was the gas constant, and T was the temperature.

### EXAMPLE 2

### Preparation of Catalyst and Calibrations

A catalyst was prepared and tested that consisted of manganese dioxide coated on “honeycomb” alumina as the support. The “honeycomb” pattern consisted of 3 mm square sections running the length of the catalyst tube. The total size of the catalyst support was 15 cm long by 5 cm in diameter but only the center 2.5 cm was used in these experiments. The rest of the catalyst was blocked. The purpose of the blocking was to increase the linear flow rate to resemble those that occur in flue gases in plants.

The manganese catalyst was made by placing the alumina substrate in a solution of manganese acetate in water or manganese acetate in acetone. The absorption of the manganese acetate solution by the catalyst was very rapid and typically the alumina substrate would be saturated within a time period of 10-15 minutes. The soaked substrate is then drained and fired in a kiln at approximately 800-900° C. for at least 30 minutes. During the firing the acetate on the substrate is converted to carbon dioxide and water by combustion. The firing process left a residual material of predominantly manganese dioxide bound on the substrate surface.

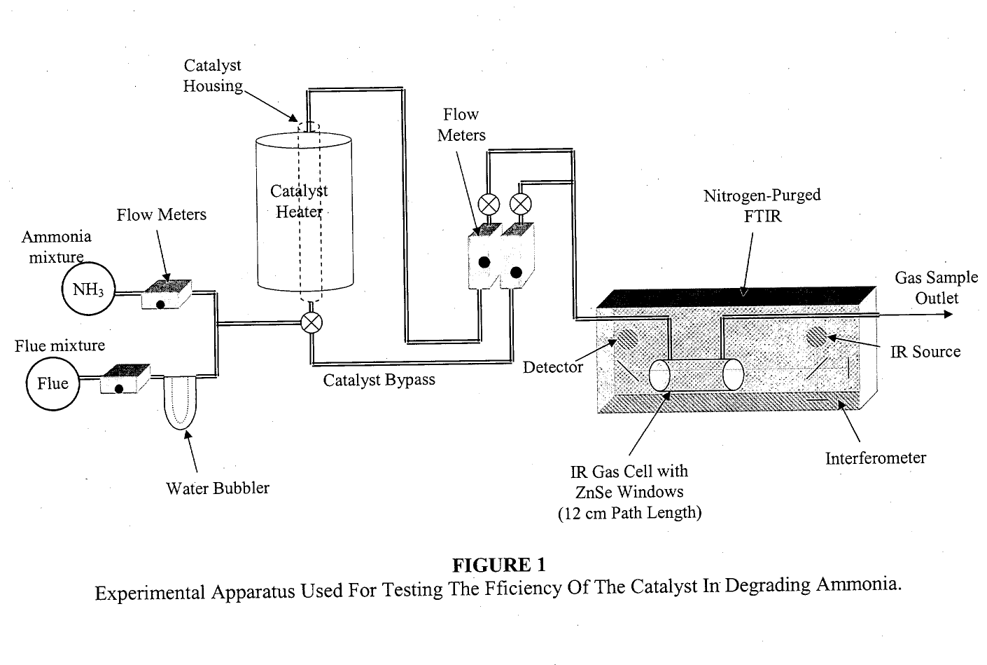

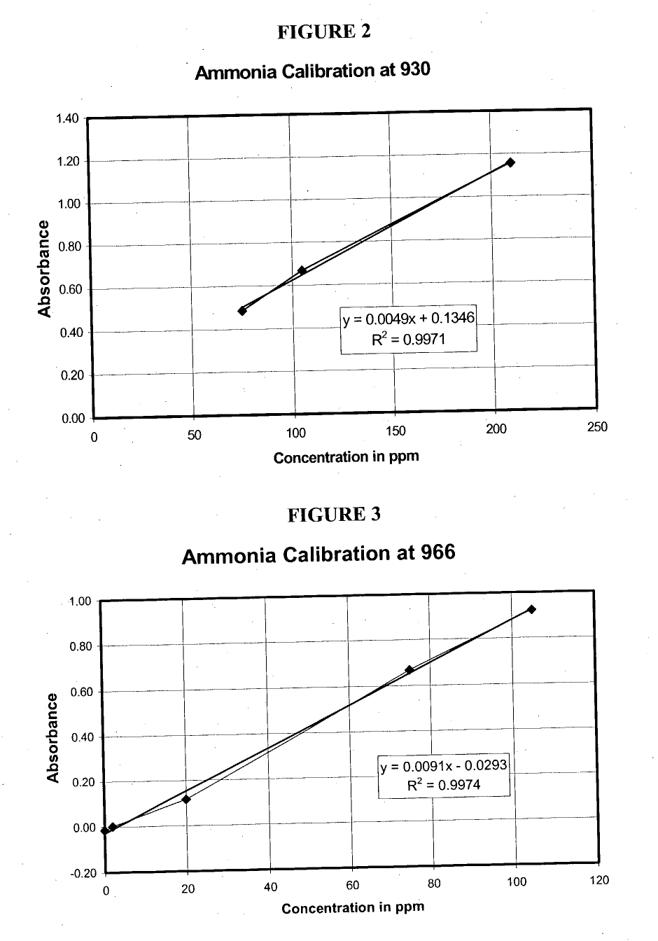

FIG. 1 is a diagram that depicts the experimental arrangement used for testing the proposed catalyst. The catalyst was placed in a catalyst housing inside a heated coil that was heated to temperatures that ranged from 100° C. to 350° C. The temperature was measured by a thermocouple that extended into the catalyst housing and contacted the internal structure of the catalyst.

Mixtures of ammonia and synthetic flue gas were flowed through the heated catalyst into an IR gas cell as pictured in FIG. 1. The synthetic flue gas was created from three separate tanks of gases. This was required to prevent any interaction between the three gases before the mixture entered the catalyst. The main tank contained a mixture of approximately 2% oxygen, 16% carbon dioxide with the remaining portion of the gas being nitrogen. A second tank contained approximately 210 ppm ammonia in nitrogen. The third tank contained 985 ppm of NOₓ, 3% sulfur dioxide and the remainder of the gas concentration was nitrogen.

When the flow from the tanks was mixed in varying ratios a wide variety of flue gases were simulated. For example, when 5% each of the ammonia and NOₓ/SOₓ tanks were mixed with 90% of the main tank (all percentages by volume) then the synthetic flue gas had the composition shown in Table 1.

TABLE 1

| | Amount by |
|---|---|
| Component | Volume |
| NH₃ | 10.5 ppm |
| NOₓ | 49.3 ppm |
| SOₓ | 0.149% |
| CO₂ | 14.0% |
| O₂ | 2.17% |
| N₂ | 83.68% |

### Simulated Flue Gas Composition

Water vapor was added to the composition in Table 1. It was generated by flowing the primary stream (from the main tank) of oxygen, carbon dioxide and nitrogen through a heated water bubbler before mixing the main gas stream with the other two gas streams from the ammonia and NOₓ/SOₓ tanks. The flow rates of all streams were measured with calibrated flow meters. Ammonia concentrations were measured using a Fourier transform infrared spectrometer equipped with a standard linearized detector, i.e., Perkin-Elmer FTIR with a DTGS detector at 2 cm⁻¹ resolution. This instrument detects compounds in the infrared range of 450 to 4400 cm⁻¹, allowing identification of a large variety of species.

Experiments were performed under various conditions. A 15 cm cell was used for the FTIR reading with flow rates up to 14 liters/minute. The flow rates of the gases were adjusted as well as the ammonia concentration until the initial NH₃ present in the gas mixture was in the range of 10-20 ppm. These measurements used a long path 10 m cell for the FTIR readings. The experiments with the short path cell consumed too great a quantity of gas at the high flow rate. With the lesser amounts of incident ammonia (20 ppm) and the lower flow, essentially complete removal of NH₃ occurred.

FIGS. 3 and 4 show typical calibrations. This calibration was performed for the long path cell. Multiple wavelengths were used as a means of checking the results. The use of multiple wavelengths eliminated any artifacts that could have been present in the data during the data analysis. The wavelengths of 930 cm⁻¹ and 966 cm⁻¹ were selected as being the least obscured by any other information from other components in the gas phase.

### EXAMPLE 3

### Ammonia Reduction

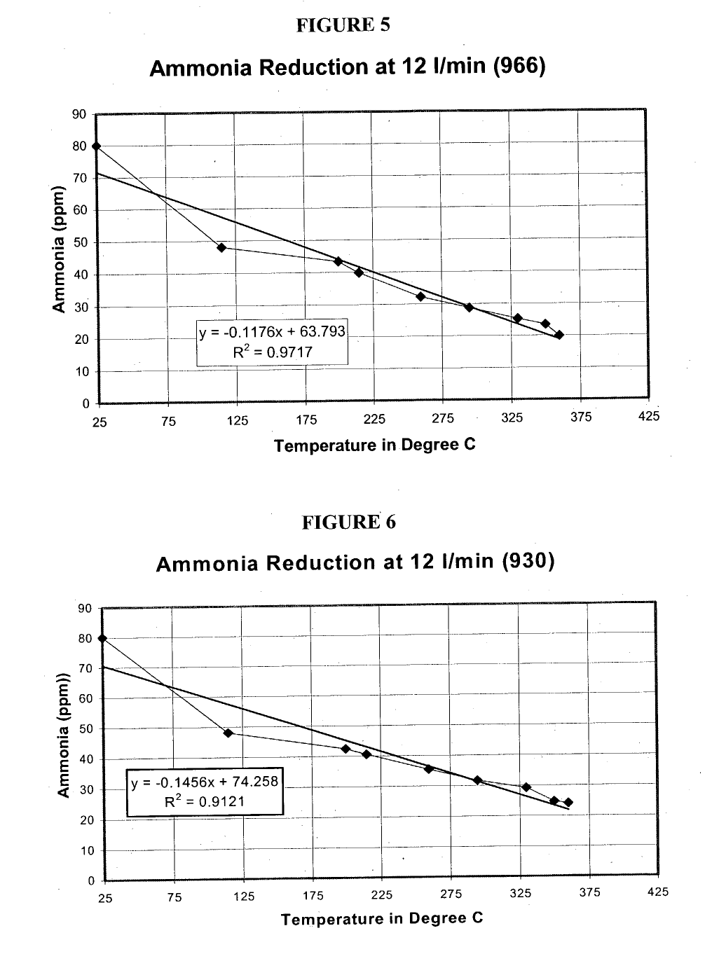

The reduction in ammonia (concentration of 80 ppm) that occurred in the system at room temperature and with a flow rate of 12 L/min. through the 74 cm³ occupied by the catalyst is shown in FIG. 5. FIG. 5 is the analysis for the 966 cm⁻¹ IR line. The surface area of the catalyst was 1,250 cm² in this configuration. This experiment was performed using the short path cell. Thus as shown in FIG. 5, at 200° C. the ammonia concentration had been reduced to 50% of the initial concentration and at 350° C. the ammonia concentration was reduced 25% of the initial concentration. FIG. 6 is the same analysis as FIG. 5 measured at the alternative wavelength.

### EXAMPLE 4

### Ammonia Reduction

The input ammonia levels were reduced to approximately the value shown in Table 1. In order to precisely measure the lower concentrations of ammonia the longer path cell was used in the FTIR analysis. The SOₓ levels in the gas were known to have a detrimental effect on the short path cell windows. The short path cell windows were destroyed by the presence of SOₓ in the simulated flue gases and had to be replaced with ZnSe which is not attacked by the SOₓ. The materials used to make the long path cell windows are unknown. Thus the SOX was left out of the gas mixture for the long path cell experiments. The SOₓ concentration did not appear to have any measurable effect on the reaction or the catalyst in the testing. The original concern for SOₓ presence was whether it would inactivate the catalyst in the long term. The same catalyst unit has been used for all of the examples so damage from the runs with SOX would have been cumulative and if there were any significant effects, these effects would have been noticeable in the ammonia reaction.

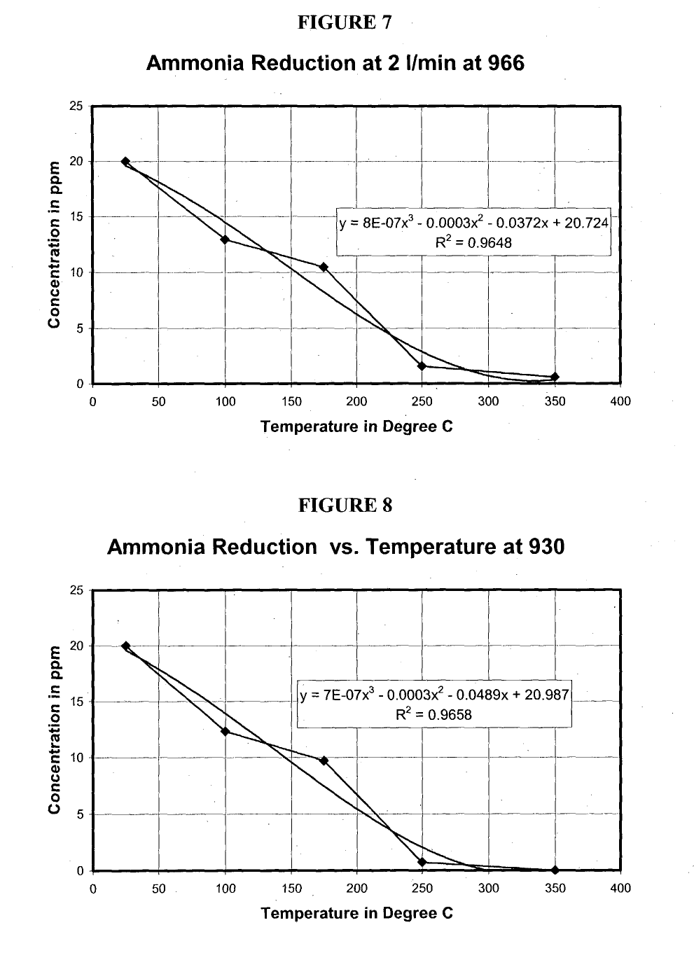

In FIG. 7 it is shown that at temperatures of 250° C. and above, the ammonia concentration was reduced to 1 ppm or less under flue gas conditions. FIG. 7 is the graph for the analysis at 966 cm⁻¹ and FIG. 8 is the analysis at 930 cm⁻¹. At 250° C. it was evident that the ammonia was reduced to the desired levels for the exiting flue gases. The space velocity at this condition was about 27. Unexpectedly this is not what one would have predicted earlier. This testing has shown that manganese dioxide on alumina catalyst removed ammonia from flue gases that are representative of power plant conditions.

This process would allow the use of greater amounts of ammonia to be used to reduce the oxides of nitrogen in the flue gases with lowered emissions. In addition the fly ash is not contaminated with ammonia and thus can be used as additives for concrete by admixture with cement.

The above presents a description of the best mode of carrying out the present invention and of the manner and process of making and using the same. This invention is, however, susceptible to modifications and alternate constructions from that discussed above which are fully equivalent. Consequently, it is not the intention to limit this invention to the particular embodiment disclosed herein. On the contrary, the intention is to cover all modifications and alternate constructions coming within the spirit and scope of the invention as generally expressed by the following claims, which particularly point out and distinctly claim the subject matter of the invention:

We claim:

1. A method of removing ammonia in flue gases where ammonia is used as selective catalytic reduction agent with a primary catalyst for reducing oxides of nitrogen which comprises:
(a) adding excess ammonia to flue gases to reduce oxides of nitrogen;
(b) selecting a secondary catalyst to reduce the ammonia in presence of about 2% or less oxygen concentration; and
(c) placing the secondary catalyst downstream from the primary catalyst; and
reducing ammonia concentration in exiting flue gases to 5 ppm or less.

2. A method as recited in claim 1 further comprising selecting a secondary catalyst so that ammonia is reduced in the presence of oxides of sulfur.

3. A method as recited in claim 1 wherein the secondary catalyst is selected from metal oxides.

4. A method as recited in claim 1 wherein the secondary catalyst is manganese dioxide.

5. A method as recited in claim 4 further comprising supporting the manganese dioxide on a substrate that is similar in geometric structure to the primary catalyst.

6. A method as recited in claim 1 wherein the flue temperatures are 100° C. to 360° C.

7. A method as recited in claim 1 wherein the ammonia concentration in exiting flue gases is 2 ppm or less.

8. A secondary catalyst as in claim 1 comprising manganese dioxide coated on honeycomb alpha or gamma alumina.

9. A method as recited in claim 1 wherein the secondary catalyst is supported on a substrate that is similar in geometric structure to the primary catalyst.

10. A process for producing manganese catalyst as recited in claim 4 which comprises:
(a) soaking substrate in a solution of manganese acetate in water or acetone;
(b) draining substrate; and
(c) firing substrate in a kiln at 800-900° C. for at least 30 minutes.

11. A method of claim 1 wherein the activity of the primary catalyst is enhanced by adding additional excess ammonia.

12. A method of preventing ammonia from depositing on fly ash in coal fired furnaces where ammonia is used as selective catalytic reduction agent with a primary catalyst for reducing oxides of nitrogen in flue gases which comprises:
(a) adding excess ammonia to flue gases to reduce oxides of nitrogen;
(b) selecting a secondary catalyst to reduce the ammonia in the presence of about 2% or less oxygen concentration; and
(c) placing the secondary catalyst downstream from the primary catalyst; and
reducing ammonia concentration in exiting flue gases to 5 ppm or less.

13. A method as recited in claim 12 further comprising selecting a secondary catalyst so that ammonia is reduced in the presence of oxides of sulfur.

14. A method as recited in claim 12 wherein the secondary catalyst is selected from metal oxides.

15. A method as recited in claim 12 wherein the secondary catalyst is manganese dioxide.

16. A method as recited in claim 12 further comprising supporting the manganese dioxide on a substrate that is similar in geometric structure to the primary catalyst.

17. A method as recited in claim 12 wherein the flue temperatures are 100° C. to 360° C.

18. A secondary catalyst as in claim 12 comprising manganese dioxide coated on honeycomb alpha or gamma alumina.

19. A method as recited in claim 12 wherein the secondary catalyst is supported on a substrate that is similar in geometric structure to the primary catalyst.

20. A process for producing manganese catalyst as recited in claim 15 which comprises:
(a) soaking substrate in a solution of manganese acetate in water or acetone;
(b) draining substrate; and
(c) firing in a kiln at 800-900° C. for at least 30 minutes.

21. A method as recited in claim 12 wherein ammonia concentration in exiting flue gases is 2 ppm or less and the fly ash is essentially ammonia free.

22. A method of claim 12 wherein the activity of the primary catalyst is enhanced by adding additional excess ammonia.

23. A method of removing ammonia in flue gases where ammonia is used as an agent in selective non-catalytic reduction for reducing oxides of nitrogen which comprises:
(a) adding excess ammonia to flue gases to reduce oxides of nitrogen;
(b) selecting an ammonia oxidation catalyst to reduce the ammonia in presence of about 2% or less oxygen concentration; and
(c) placing said ammonia oxidation catalyst downstream from the furnace; and
reducing ammonia concentration in exiting flue gases to 5 ppm or less.

24. A method as recited in claim 23 further comprising selecting an ammonia oxidation catalyst wherein ammonia is reduced in the presence of oxides of sulfur.

25. A method as recited in claim 23 wherein said catalyst is selected from metal oxides.

26. A method as recited in claim 23 wherein said catalyst is manganese dioxide.

27. A method as recited in claim 26 further comprising supporting the manganese dioxide on a geometric substrate.

28. A method as recited in claim 23 wherein the flue temperatures are 850° C. to 1150° C. and the ammonia oxidation catalyst temperatures are 100° C. to 360° C.

29. A method as recited in claim 23 wherein the ammonia concentration in exiting flue gases is 2 ppm or less.

30. An ammonia oxidation catalyst as in claim 23 comprising manganese dioxide coated on honeycomb alpha or gamma alumina.

31. A process for producing manganese catalyst as recited in claim 27 which comprises:
(a) soaking substrate in a solution of manganese acetate in water or acetone;
(b) draining said substrate; and
(c) firing said substrate in a kiln at 800-900° C. for at least 30 minutes.

32. A method of preventing ammonia from depositing on fly ash in coal fired furnaces where ammonia is used with selective non-catalytic reduction for reducing oxides of nitrogen in flue gases which comprises:
(a) adding excess ammonia to flue gases to reduce oxides of nitrogen;
(b) selecting an ammonia oxidation catalyst to reduce the ammonia in the presence of about 2% or less oxygen concentration; and
(c) placing said ammonia oxidation catalyst downstream from the furnace; and
reducing ammonia concentration in exiting flue gases to 5 ppm or less.

33. A method as recited in claim 32 further comprising selecting an ammonia oxidation catalyst wherein said ammonia is reduced in the presence of oxides of sulfur.

34. A method as recited in claim 32 wherein said ammonia oxidation catalyst is selected from metal oxides.

35. A method as recited in claim 32 wherein said ammonia oxidation catalyst is manganese dioxide.

36. A method as recited in claim 35 further comprising supporting the manganese dioxide on a geometric substrate.

37. A method as recited in claim 32 wherein the flue gas temperatures are 850° C. to 1150° C. and the ammonia oxidation catalyst temperatures are 100° C. to 360° C.

38. An ammonia oxidation catalyst as in claim 35 comprising manganese dioxide coated on honeycomb alpha or gamma alumina.
